(19) United States
(12) Patent Application Publication
(10) Pub. No.: US 2018/0238994 A1
(43) Pub. Date: Aug. 23, 2018

(54) POSITIONING SYSTEM AND METHOD WITH STEGANOGRAPHIC ENCODED DATA STREAMS IN AUDIBLE-FREQUENCY AUDIO

(71) Applicant: UNIVERSIDADE DO PORTO, Porto (PT)

(72) Inventors: Diamantino Rui DA SILVA FREITAS, Porto (PT); João NEVES MOUTINHO, Porto (PT); Rui Manuel ESTEVES ARAÚJO, Porto (PT)

(21) Appl. No.: 15/552,878

(22) PCT Filed: Feb. 23, 2016
(86) PCT No.: PCT/IB2016/050980

§ 371 Date: Aug. 23, 2017

(30) Foreign Application Priority Data
Feb. 23, 2015 (PT) 108242

(51) Int. Cl. G01S 5/30; G01S 11/14; G10L 19/00

(52) U.S. Cl. CPC G01S 5/30; G10L 19/00; G01S 11/14

(57) ABSTRACT

A system and method for location positioning with steganographic encoded data streams in audible-frequency range audio is disclosed. The method comprises encoding, modulating and audio-hiding data streams into corresponding audible-frequency range steganographic audio signal; transmitting each audio signal by a corresponding loudspeaker, wherein each data stream includes the geographic location of the corresponding loudspeaker, a time stamp of transmission of periodic frames of the data stream and the like. In addition, a mobile device is used for: acquiring an audio signal that includes the transmitted audio signals; separating, demodulating and decoding the data streams therefrom; calculating the distance between the mobile device and each of the loudspeakers based on the time of flight between transmission and acquisition of each of the audio signals; and estimating the geographic location of the mobile device based on the distance between the mobile device and the loudspeakers and the geographic location of the loudspeakers.

### TECHNICAL FIELD

The present disclosure relates to an audio positioning system and method with steganographic encoded data streams. In particular the disclosure includes a system and method for determining a spatial position by a data processing mobile device (such as a smart-phone, tablet, etc.) by means of audio signals, broadcasted in the area of interest, periodically by an infrastructure, barely or not perceptible to people, transmitted through air, containing relevant information necessary for the mobile device global position and, optionally, other infrastructure information.

### BACKGROUND

Most GPS alternatives, particularly in indoor spaces, are based on wireless communication systems like Wi-Fi, UWB, BLT, NFC or RFID. These approaches are characterized by their low accuracy or associated high costs for achieving accurate ranging.

More recently, with the advent of smartphones and tablets, new approaches which rely on dead reckoning with the use of fused data provided by the inertial measurement unit (IMU), can provide an almost infrastructure independent localization system. However, even with the use of tools which evaluate human gait and behavior, cumulative errors occur and navigational aids are needed in order to give accurate information, not only to correct positional errors but also to calibrate dead reckoning algorithms. Absolute reference points become necessary and the simple use of inertial information does not solve the problem.

In an infrastructure based approach, other localization systems use floor sensing and establish a sensor grid to detect a user's position. This possibility is only viable in small areas or with a very low position granularity, as it imposes high costs of installation due to the amount of necessary sensors and possible necessary construction works. In the scenario where the floor has emitters instead of sensors, the same disadvantages occur, but with the possibility of centering the localization estimation on the mobile device's side. Nevertheless, a special custom made mobile device, or at least a special sensor is required to be able to read its position from the floor emitters.

In another perspective, other localization possibilities use ultrasonic signals, inaudible to humans, to measure short distances as the ones involved in indoor spaces. However, ultrasonic signals require line-of-sight between emitting anchors and the mobile device as the wavelength of this type of signal is short and the small diffraction or spreading occurs. As such, it would require many emitters (not usually present or frequent) transmitting ultrasonic signals (not usually present) to ensure enough coverage of any area. It is also important to consider that these signals are highly attenuated through air and both transmitter and receiver have to be custom made devices, as typically ultrasound signals are not used in everyday life.

Document WO2013132393 A1 uses sound masking signals but completely differs in the architecture and in the way signals are used to achieve positioning. Patent WO 2001034264 A1 describes an acoustic relative location system, also with the use of a perceptually masked signal, however it significantly differs as it is focused on limited relative positioning. In the case of US 20130188456 A1, where ambient sound is used with the purpose of localization, the US document uses different types of signal and thus differs in the results obtained.

These facts are disclosed in order to illustrate the technical problem addressed by the present disclosure.

### General Description

Location awareness in context-based applications is becoming one of the most compelling areas in technology and user demand. For instance, the Global Positioning System (GPS) is nowadays built into most mobile devices such as smartphones, laptops or tablets. However, there are many situations, typically indoors, where GPS based-systems do not work properly because most signals are largely attenuated when traversing walls. This limitation opens space to the appearance of alternatives to position determination systems and technologies.

Considering the existent approaches and considering their flaws, a new type of system is described to overcome the localization problem by using audio signals to allow global localization of a mobile device. The lower frequency of this acoustic signal when compared to ultrasound overcomes the problem of signal coverage and allows the use of off-the-shelf devices like loudspeakers and mobile devices with microphones and internal processing such as smartphones. Another important advantage is the possibility of using data transmission from the anchors to the mobile device (necessary to allow global absolute localization) only possible with a good signal coverage and therefore much more difficult to achieve with ultrasound. Also to consider is the easiness of synchronizing an acoustic signal which travels almost 882000 times slower than a radio signal that requires very precise clocks. However, the clear disadvantage in using such acoustic signals is related with the fact that humans can ear audio signals and it is not immediate to imagine a solution for this obstacle. Nonetheless, a possible solution for this problem was found and methods and systems where developed to successfully allow global absolute localization with the use of everyday and maybe pre-existent off-the-shelf devices without disturbing people present in the same acoustic environment.

The disclosure presents unlikely and surprisingly compatible aspects: an audio signal being transmitted continuously (or intermittently) in the relevant place, in a way barely or not perceptible to people, carrying information that allows a mobile device to estimate its global position. Another differentiating aspect to the other audio-based approaches is the fact that no interaction with the infrastructure is required (increasing security and privacy) and no previous knowledge of the local area is needed.

### BRIEF DESCRIPTION OF THE DRAWINGS

The following figures provide preferred embodiments for illustrating the description and should not be seen as limiting the scope of invention.

FIG. 1 illustrates a general view of the relation between infrastructure and the mobile devices. It includes an embodiment relative to the physical components of the system: an infrastructure with one or more loudspeakers transmitting carefully conceived audio signals and/or mixed with the pre-existent public address audio signal; the channel with a simplified characterization; and the mobile device (to be self-localized) with its microphone and processing capabilities capable of receiving the audio signals continuously or intermittently emitted, processing them and to estimate its absolute global position. The mobile device, with suitable processing capabilities, is responsible for:
Range determination of each signal by correlation techniques or matched filters;
Demodulation and decoding (data hiding, channel decoding, information unpacking);
Relative position estimation by using range based estimations;
Absolute global position estimation by using information regarding the infrastructure's absolute position and/or geographical data from each one of the loudspeakers.

FIG. 2 presents some of the details of an embodiment considering its several building blocks necessary to successfully perform absolute self-localization by using audio signals barely (or even not) perceivable.

FIG. 3 is based on FIG. 2 and presents an embodiment of the system in an experimentally verified setup which demonstrates the validity of the principles.

FIG. 4 presents a diagram with correlation peaks for each received signal from each anchor.

FIG. 5 Illustrates a sequence regarding the localization calculation process in optimal conditions (no errors in distances) and considering three anchors, in a first step where the potential localization is somewhere on the t1 radius circle, in a second step where the potential localization is one of two intersection points of the t1 and t2 radius circles, and a third step where the localization is the point that also passes through the circle t3.

FIG. 6 presents a location estimation problem based on noisy ToF (time of flight) measurements.

FIG. 7 presents a 25% circle shrinking illustration. The overestimated distance vectors on each beacon are iteratively reduced to minimize the solution space.

FIG. 8 presents the use of the system in already present public address sound systems.

FIG. 9 presents a frequency plot of a Spread Spectrum-Binary Phase Shift Keying signal in the human's audible range (in light gray) lying bellow the environmental noise level (in darker gray/black).

FIG. 10 presents an illustration of circle shrinking without range measurement errors for two anchors.

FIG. 11a presents an illustration of circle shrinking without range measurement errors for three anchors.

FIG. 11b presents an illustration of circle shrinking with range measurement errors for three anchors. The range measurement errors illustrated in the inferior area of the FIG. 11b may be due to noise in the ability to detect the correct arrival instant of the signal to itself (mobile device) or may be due to different delays in a non-simultaneous emission by the anchors. This latter may be compensated by the mechanism described in FIG. 13, where emission of pre-known delayed anchors is anticipated and simultaneous emission is guaranteed.

FIG. 12a presents an illustration of circle shrinking without range measurement errors for 4 anchors (beacons) with relative localization.

FIG. 12b presents an illustration of circle shrinking without range measurement errors for 4 anchors (beacons) with absolute global localization.

FIG. 13 presents an illustration of the signals received by 4 anchors (beacons) obtained from an emission after a delay t₀ where the anchors, either do not have individually different delays in transmission, or do have individually different delays in transmission which are compensated after reception.

### DETAILED DESCRIPTION

The disclosure is characterized by a set of systems and methods to allow global absolute position estimation in a processing enabled mobile device (such as a smartphone, tablet, etc.) by means of audio signals. These audio signals are transmitted periodically by an infrastructure without any connection to the mobile device and are present all the time even if no mobile device is using them. Although by nature in the audible frequency range, these signals are designed to be barely perceptible to people avoiding disturbing the acoustic environment and people that may be present in the same area. Inside these signals transmitted through air, relevant information concerning the global position determination is transmitted in a one way, non-confirmed, communication channel to the mobile device. The possibly moving mobile device, requires special processing to allow Doppler effect compensation.

Physically, the system is composed by an infrastructure, the channel and a mobile device (as FIGS. 1 to 3 describe):

The following pertains to the disclosure's infrastructure. The fixed part of the system, present the physical architecture of the area where localization is performed. As FIG. 1 depicts, it is composed by one or more loudspeakers emitting regularly audio signals together and in consonance with possible pre-existent public address sound emissions. Each loudspeaker emission is composed by a sequence of operations that creates the signal do be emitted to the channel. Useful data like the loudspeaker position, the air temperature, or simply some area identification, is packed in a frame; an error-correcting code is applied to that frame; perceptual masking, making use or not of the present or not public address sound signal, together with a modulation block that prepares the signal do channel transmission and creates its unique signature, will ready the signal to be emitted together with the other loudspeaker's signals.

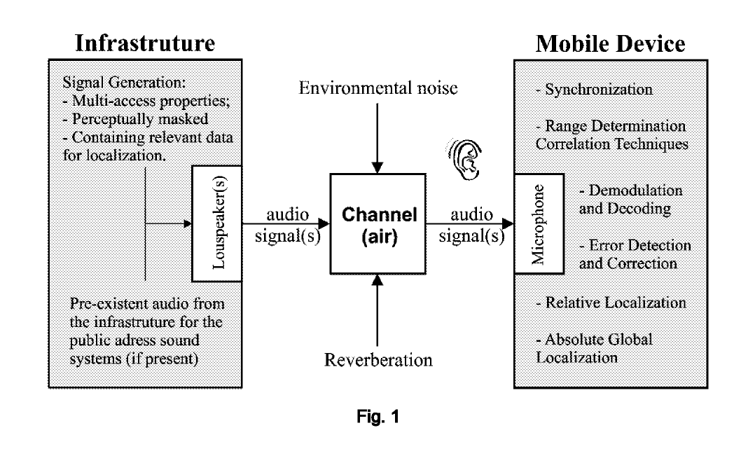

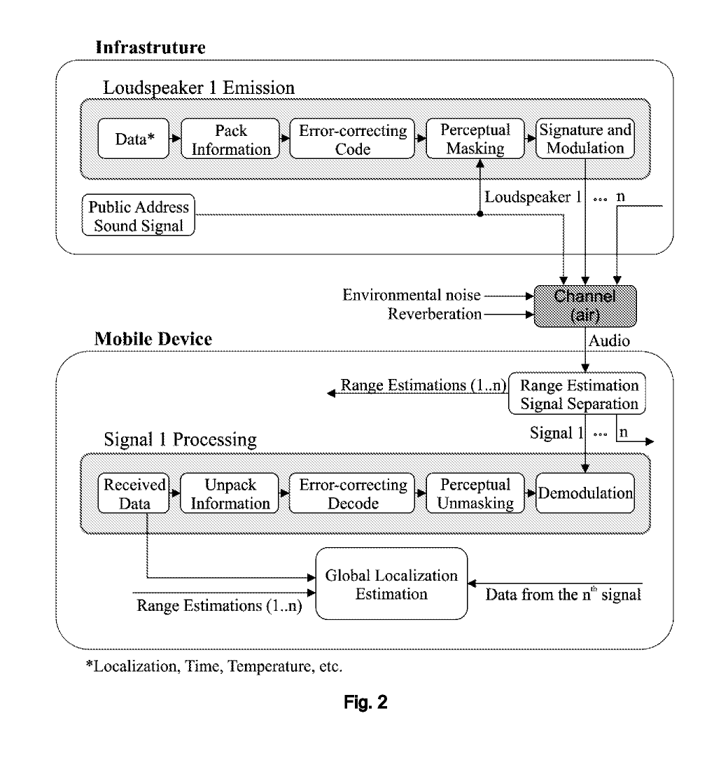

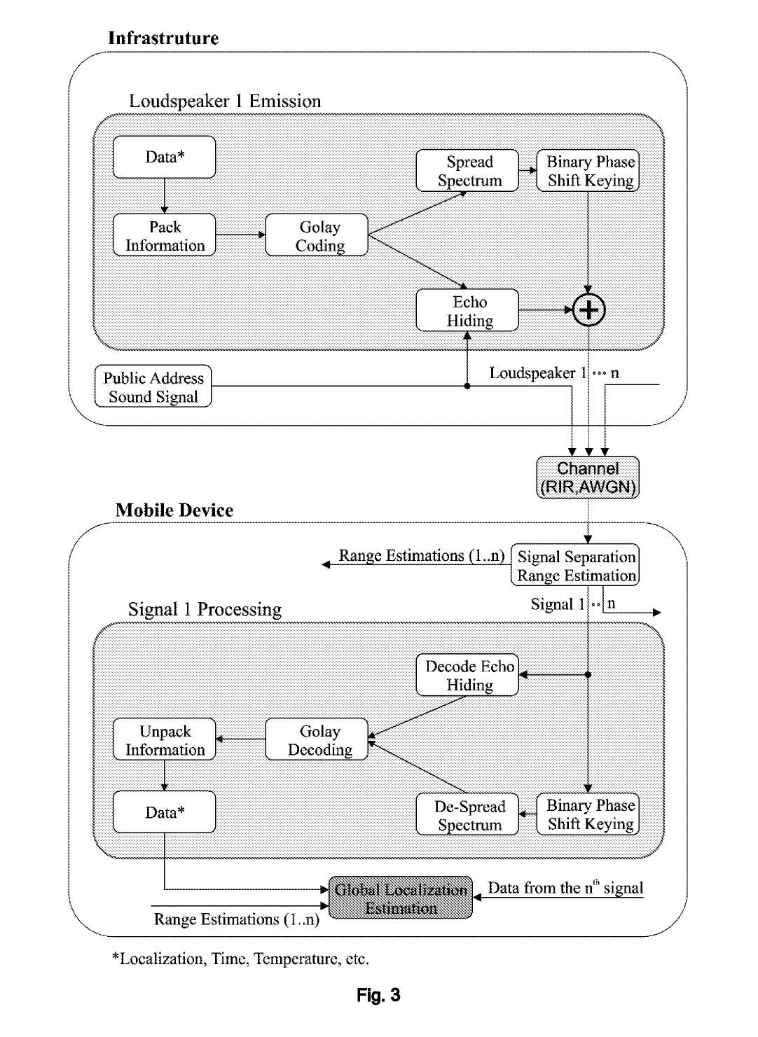

FIG. 3 describes an embodiment of FIG. 2, with a possible application of this disclosure, where the several parts that compose the system were already experimentally verified by the authors and in literature. In this embodiment, Golay codes are used as the error-correcting tool to transmit data. The use of Spread Spectrum multiple access transmission technology, together with the use of Gold or Kasami codes for instance, allows simultaneous loudspeaker transmission use while simultaneously performing a perceptual masking technique based in spreading the signal energy through the available frequency range and slightly below the environmental noise. Together with the especially created Spread Spectrum signals, this embodiment example also uses the Echo Hiding technique (a data hiding technique) to send information to the mobile device (in this case, the environment temperature, useful to more accurately determine ranges by measuring signal time-of-flight) by using the possibly existent the public address sound signal.

The following pertains to the disclosure's channel. In this disclosure, the channel is the air in which audio waves travel from infrastructure anchors, typically loudspeakers, to reach a mobile receiving device with a microphone (possibly a smartphone). Reflections, reverberation, multipath and noise, greatly affect successful communication and use of the emitted acoustic channel. Nevertheless, it is not a controllable aspect of the disclosure as it may assume different scenarios (indoor and outdoor, in different physical architectures). The remaining parts (infrastructure and the mobile device) are designed to deal with every possible scenario of air indoor/outdoor transmission.

The following pertains to the disclosure's mobile device. The mobile device, integrating a microphone and possessing processing capabilities, is responsible for acquiring signals and perform its global position estimation. FIG. 2 illustrates the sequence of events that follow: range estimation to each of the loudspeakers in the vicinity (by using a peak detection method in suitable correlation technique) and signal separation so that data extraction is possible. Each separate signal is then demodulated and digital data is revealed by unmasking its content. Error-correction decoding is them performed and information is unpacked to be used in the global position estimation. Range information by itself does not provide localization. Only with the use of the data transported by the signal, for instance the global position of each loudspeaker, it will be possible to achieve it.

In FIG. 3, a mobile device embodiment is also presented concerning an experimentally confirmed scenario where Spread Spectrum signals from loudspeakers are received by the mobile device's microphone and ranges to loudspeakers are estimated. Through demodulation and de-spreading of the previously separated signals, the Golay encoded sequences are revealed and by decoding them, data is retrieved that will provide the global position of the loudspeakers which emitted each signal. Using this information together with the previously determined ranges, will allow global position determination either by simple proximity (in a single loudspeaker scenario) or by tri/multilateration/angulation. Available in the received signals, echo hidden information, is also found in this embodiment containing information regarding the temperature to allow more accurate range estimations, as sound propagation speed is significantly affected by the air temperature. Other possibilities of useful information transmitted by the infrastructure to the mobile device, may concern helping the global localization estimation by proving some geographical cues concerning the infrastructure location, speeding up or the position determination or diminishing position ambiguity.

To estimate localization it is necessary to rely on a referential with known position. In this infrastructure-based approach where fixed anchors emit signals to a mobile device, localization can be achieved by measuring the distance between these parts. These distance vectors where d represents the distance to the anchor, can be obtained using the time of arrival (TOA) technique: the time of reception of the signal by the mobile device. Knowing the signal arrival time and subtracting it to the departure time, will provide the duration the signal took to reach the receiver, time of flight (ToF), and allow distance measurements. It is the most efficient and usual choice among the options to infer on distance, as it uses the minimum number of necessary anchors (three for two-dimensional localization). If a signal propagates with a constant velocity v₀, the distance dᵢ can be calculated by:

dᵢ=ToF×v. (1)

It is necessary to consider that sound velocity may be influenced by air temperature and humidity. Considering temperature variation, it increases at a 0.6 m·s⁻¹·C.⁻¹ rate at 0° C. Sound velocity 17 will therefore be

$$v = 331.45 \sqrt{1 + ( \frac{T}{273.15} )} . \qquad ( 2 )$$

where T is temperature in Celsius. Humidity has a small effect on sound speed. It increases it by about 0.1% to 0.6% because oxygen and nitrogen molecules on the air are replaced by lighter molecules of water. This is a simple mixing effect. However, high humidity causes a higher sound attenuation and fading and therefore sound travels smaller distances. Yet, this consideration is not relevant in indoor spaces and can be neglected.

Distances dᵢ between anchors and the mobile device, are defined by

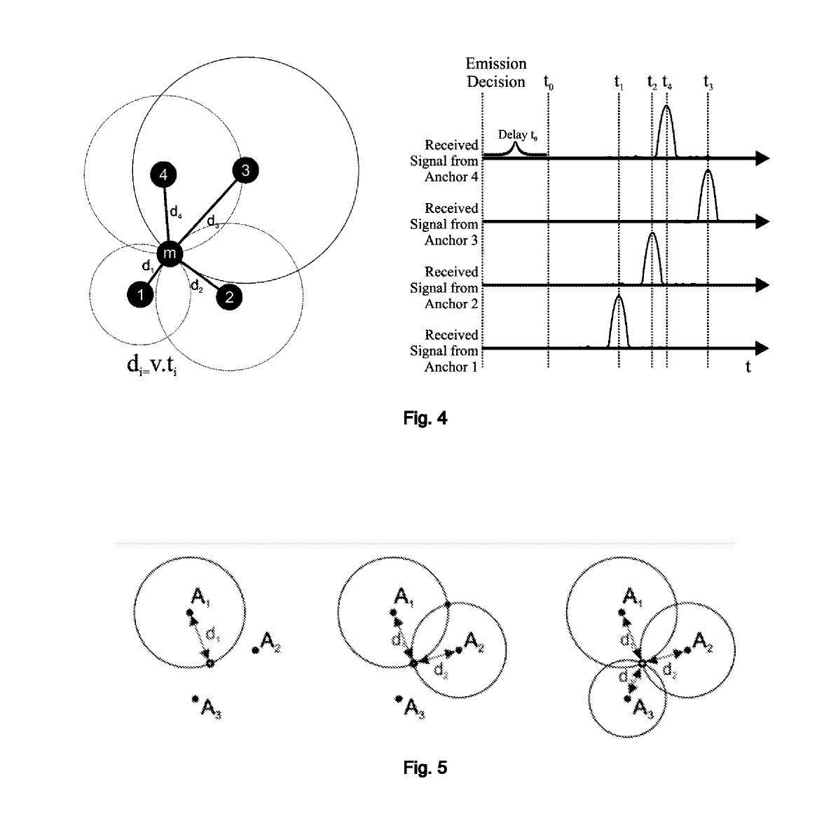

dᵢ=v₀(tᵢ−t₀)=\sqrt{(x−Xᵢ)²+(y−Yᵢ)²}, (3))

where Xᵢ and Yᵢ are the ith beacon's known and fixed coordinates, tᵢ the arrival time of each beacon's wave and t₀ the simultaneous emission time, common to all the anchors. The variables x and y are the unknown coordinates to be determined. The arrival times tᵢ of the signals may be estimated using correlation methods as FIG. 4 describes.

ToF measurements for range estimation are the most important information for the localization estimation. If the error is not systematic, localization errors will occur if the tᵢ values in equation (3) are not well determined. Therefore emphasis should be taken in determining the best possible methodology to evaluate ToF accurately. A “comparison” between the sent signal and the received one will allow the estimation of the delay and the associated distance. Cross-correlation is the simpler tool to use. Depending on the noise and in signal similarity, it can provide a good enough peak allowing determining delay, as may be read in the following equation:

Rᵣ_{₁}ᵣ_{₂}(τ)=E[r₁(t)r₂(t−τ)], (4)

where R₍ᵣ_{₁}ᵣ_{₂}₎ represents the cross-correlation between r₁ and r₂ and E{.} is the expected value. The delay τ is the value that maximizes this function in delay estimation. The time delay D_{cc} is calculated as

D_{cc}=arg_{τ}max [Rᵣ_{₁}ᵣ_{₂}(τ)]. (5)

The sharper the peak of R₍ᵣ_{₁}ᵣ_{₂}₎(τ) will be, the better tᵢ is measured. Between several correlation methodologies available in the literature, generalized cross-correlation phase transform (GCC-PHAT) provides a sharper peak in these conditions. The main advantage of PHAT algorithm is its ability to avoid causing spreading of the peak of the correlation function.

Rᵣ_{₁}ᵣ_{₂}(τ)=∫_{-∞}^{+∞}ψₚGᵣ_{₁}ᵣ_{₂}(f)e^{j2πfτ}df, (6)

where Gᵣ_{₁}ᵣ_{₂}(f) is the cross-spectrum of the received signal and ψₚ(f) is the PHAT weighting function which is defined by:

$${ψ}_{p} ( f ) = \frac{1}{\vert {G}_{{r}_{2} {r}_{2}} ( f ) \vert} . \qquad ( 7 )$$

The PHAT filter has the effect of removing all energy content from the cross spectrum. Its computational simplicity combined with its adequacy for noisy, reverberant environments like the one in the conducted experiment justifies its use in this experiment.

If i anchors are transmitting simultaneously, the receiver must be able to identify which anchor signal was received at what tᵢ time. Also, people can ear in the frequency range where the audio signals operate and therefore acoustic annoyance should be avoided. Considering these requirements, transmission signal is carefully designed to fulfil these demands. Therefore, the transmitted signals were designed to be the most acoustically imperceptible possible to people while allowing good performance in identification. This is achieved by using signals with high autocorrelation and low cross-correlation. With the spread-spectrum encoding technique, a pseudorandom noise (PN) sequence is turned into a low power signal spread across a widespread frequency interval. This is different from schemes which encode their data in the time domain. Each loudspeaker's PN sequence should be statistically uncorrelated so that each anchor signal is correctly identified. Gold codes are a suitable example of a PN for this purpose as the correlation between codes is low and autocorrelation is high. Gold codes have bounded small cross-correlations within a set. A set of Gold code sequences consists of 2ⁿ−1 sequences each one with a period of 2ⁿ−1. These are constructed by XOR-ing two maximum length sequences of the same length with each other. Gold sequences have better cross-correlation properties than maximum length sequences and therefore its use is more appropriate. Also, a large number of different Gold codes can be generated, and that may be necessary to allow separate identification of a larger set of anchors. Each emitting signal is therefore identified by its code that spreads the data. Direct sequence code division multiple access (DS-CDMA) is then used to transmit the unique wide band coded signal shaped to the acoustic channel to a digital modulation scheme such as binary phase-shift keying (BPSK). It will convey the information contained in the spread spectrum signal by changing, or modulating, the phase in two possible values: 0 and 180°. This modulation is the most robust easier to demodulate at reception and decision can only assume two possible decisions and therefore be less influenced by noise.

Once all dᵢ vectors are measured, localization may be estimated as illustrated in FIG. 5. Localization accuracy will be a function of the number of anchors. One anchor only allows to localize the mobile device in a circumference. Using two anchors still creates uncertainty between two possible localizations. Three anchors may allow a single localization.

Estimating localization is more difficult than the FIG. 5 suggests because the physical system, which includes the sound production's and sensing software and hardware, is not linear and distance measurements may have noise.

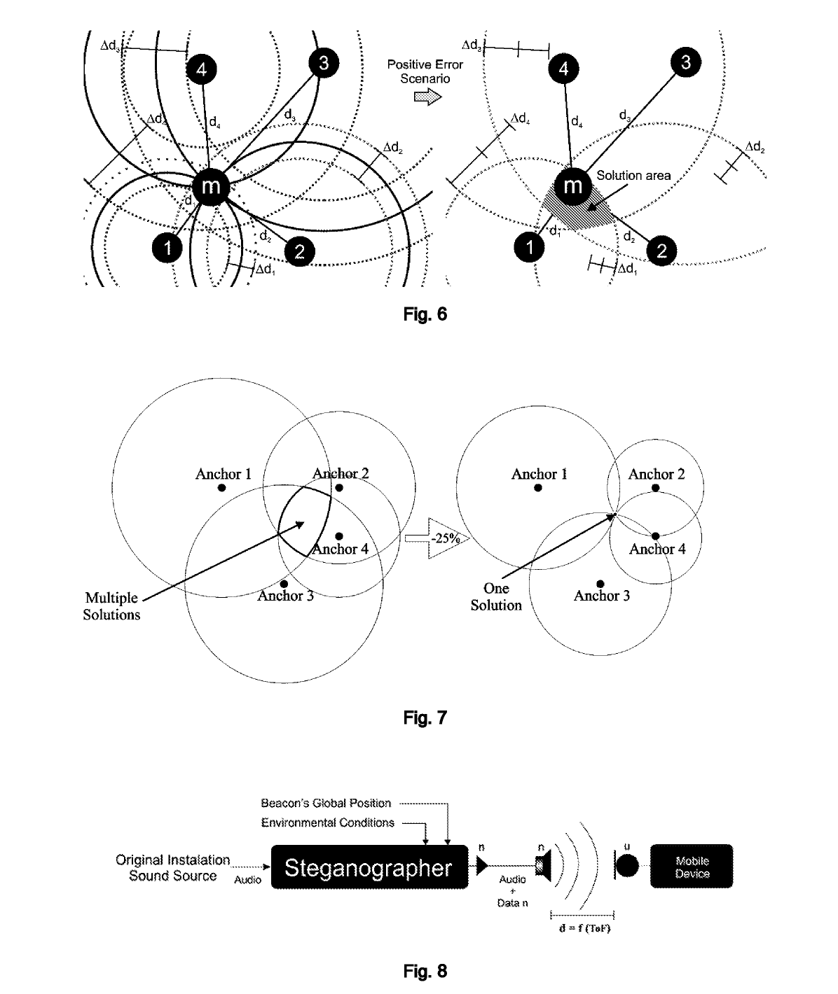

To illustrate this situation, FIG. 6 depicts a case where different errors in dᵢ will create a larger solution area for the problem, creating the need for an optimization method. The solution is no longer the circles' interception point that FIG. 5 ideally describes on the right side.

Determining t₀ is critical to correctly evaluate distance. However, not knowing t₀ is not critical if emission is simultaneous in all beacons since any over or underestimation in distance affects all the distance vectors dᵢ with the same error Δd. In these conditions, this delay may be added/subtracted using a specially developed technique called “Circle Shrinking”. In this technique, distance is usually overestimated (because of latency in the emission) and one can think the dᵢ values as the radius of circles, centered in the beacon's positions with radius equal to the overestimated distances as FIG. 7 illustrates on the left. The method iteratively starts shrinking the circles until the interception area between them is minimized as it is shown in the same figure on the right.

The local search halt criterion can be a threshold or simply a “stop when there is no interception”. However, performing “circle shrinking” can be computationally demanding. It requires calculation of the interception area at every iteration of this minimization problem. One must take into account the application requirements in precision and accuracy to evaluate what is reasonable. Sometimes, a small estimation error in the distance vectors may be acceptable. The source localization algorithm may deal with it very well. For example, one-sample error in ToF estimation at 44.1 kHz represents less than a centimeter error in a distance vector from a beacon, and an even smaller error in the final position estimation. Depending on the latency variation (Δt₀) or the application itself, one can also perform this technique only when synchronization between the emitters and the receiver is lost. This will avoid heavier processing and will increase position refresh rate. To sync the infrastructure with the mobile device, a possible approach may be to send the t₀ information on the radiated signal as a time stamp. In a scheme where DS-CDMA is used, the signal information can be the exact time of emission spreaded with a code interpreted in the receiver. Another possibility is to use a clock (sync) signal together with the signals at every cycle. A previous work has used a dedicated microphone in a known position to calculate the delay each time. It is a simple possible solution but it requires additional hardware with implied additional costs. In the conducted experiment presented ahead, a sound board with a fixed latency was used to avoid the use of such calibration microphone. Assuring fixed latency in sound emission, and therefore a constant delay, will allow to use circle shrinking only once for the first delay measurement. From that point beyond, delay is considered constant and is simply subtracted resulting t₀=0. This strategy avoids the need for additional hardware and does not increase computational complexity.

Localization can also be determined by a source localization algorithm that considers an error minimization approach. A non-linear optimization method can be used to estimate (x,y) by minimizing the following objective function concerning the error:

min f(x,y)=Σᵢ[\sqrt{(x−Xᵢ)²+(y−Yᵢ)²}−v₀·tᵢ]², (5)

where f represents the error function, and one considers the typical constrains in the variable's domains.

Iterative nonlinear least square estimation methods like the Newton-Raphson, Gauss-Newton or Steepest Descent appear in the literature to provide alternatives to this problem.

Having more anchors than the mandatory three may seem unnecessary, however, redundancy may increase robustness. It may be useful to rely on extra anchors in case some physical obstruction occurs. Thus, redundant anchors may be employed creating an overdetermined equation system. Due to the presence of noise Δdᵢ in the dᵢ measurements, the desired and unknown mobile device's position (x,y) can't be obtained just by solving the system of equations. Thus, the need for an algorithm that considers an error minimization approach.

There are many advantages in using a passive localization method. The most relevant ones are related to security, privacy and autonomy. The typical GNSS is an example, as the satellite constellation is not aware of the activity of the receiver. A simple GNSS receiver achieves global positioning just by having satellites line-of-sight and, similarly, an indoor mobile device may do so just using signals already available in that space, with similar advantages. However, a reliable one-way communication between anchor(s) and a mobile device through a shared multi-use noisy channel (many times with impulsive background noise) with strong fading and multipath and populated with persons is not a simple task to achieve.

In the presented technology, in which information concerning the anchor's position travels through the channel embedded in the signal, successful data transmission is critical. Even if the MDP with respect to the anchors is precisely determined, if the anchor positions are wrong due to bad reception this will result in bad positioning, localization estimation can be the wrong indoor infrastructure. Therefore, the data transmission problem must be assumed as one of the most important parts of this global localization system. Therefore redundancy, error detection/correction and filtering techniques are employed to avoid significant errors.

The chosen position format to transmit global position was the Universal Transverse Mercator (UTM), typically described by a grid with latitude and longitude in meters. This rectangular format was chosen for being the most universally accepted by Localization-Based Applications (LBA) and one that provides faster and simpler calculations. The MDP can be estimated by the NLS method just by “adding” the rectangular components of the range vector to the anchor's position.

Since it is not possible to generate the error signal and request retransmission, as is done in many difficult communication channels, simple error detection is not enough. Therefore it is very important to employ other solutions and the use of Forward Error Correction (FEC) appears to be very convenient. To do so, Golay codes are used to encode the data allowing error detection and correction to a significant extent. In this application, where a processing may probably be held by a device with limited computation/battery autonomy, Golay codes are the preferable choice among other error correcting tools like, for example, Reed Solomon codes, due to their relatively small computational complexity of O(n). Golay codes therefore handle random bit errors as they tolerate three bit errors per 24 bits (a codeword)—a 12.5% bit error rate compensating the fact that data retransmissions cannot be requested by the receivers operating passively.

To avoid people's perception of added audio signals, spread spectrum and echo hiding techniques are used. The audio mix is them transmitted by the loudspeakers to the channel (an indoor area). Mobile devices will be responsible for receiving the signals broadcasted in the acoustic environment and interpreting them to determine the localization, just as Global Navigation Satellite Systems do.

Considering a room in a building with a pre-existent public address sound system, the only necessary addition would be an appliance between the original sound source (possibly a mixer for a music player and voice) and the sound transducers. This appliance, illustrated in FIG. 8, would be configured considering the absolute global localization of the beacons (loudspeakers) and the environmental conditions.

The entitled “steganographer” block is responsible for choosing the best transmission scenario depending on the current condition of the public address sound system. It will perform leveling and will choose the most suitable masking technique.

In a scenario where there is no audio signal being reproduced a spread spectrum noise-like transmission is used by assuring a noise power level below the environmental noise.

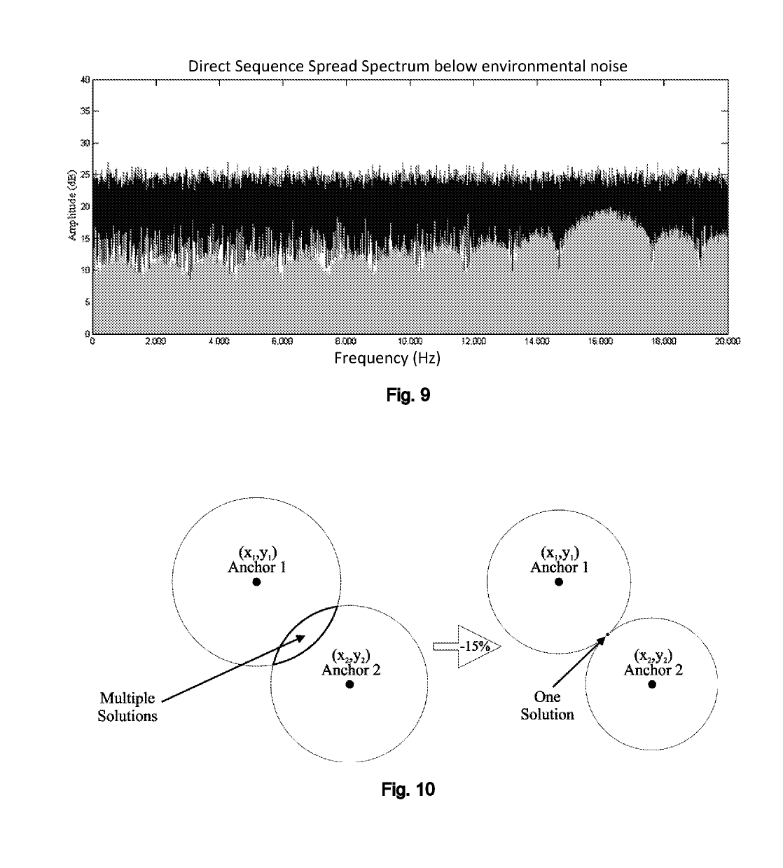

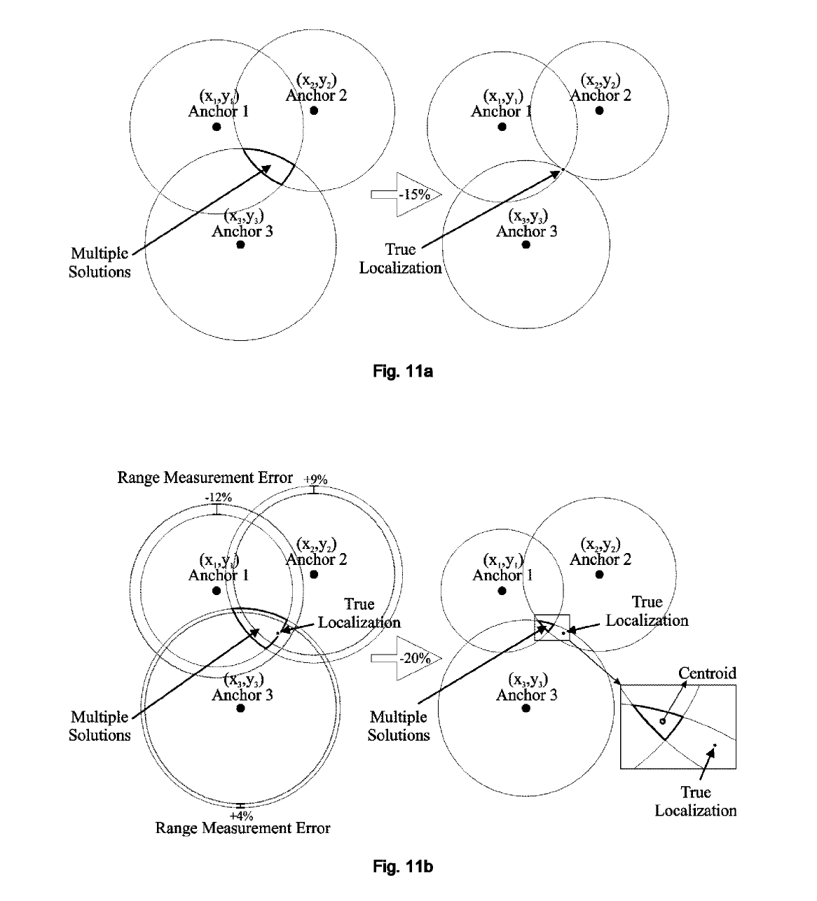

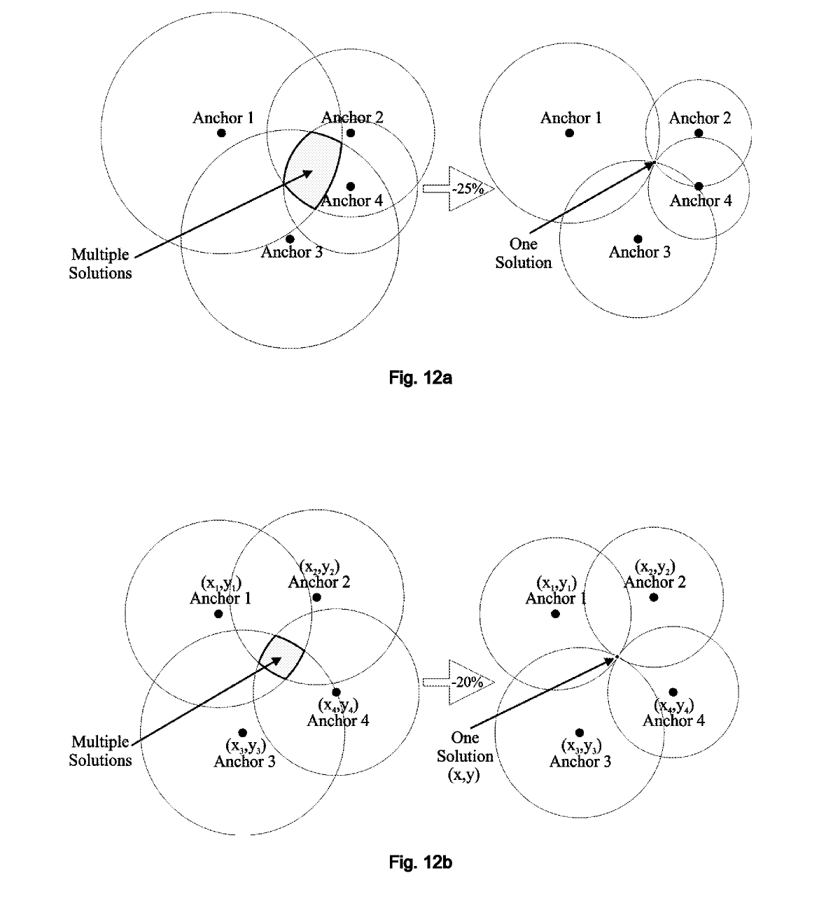

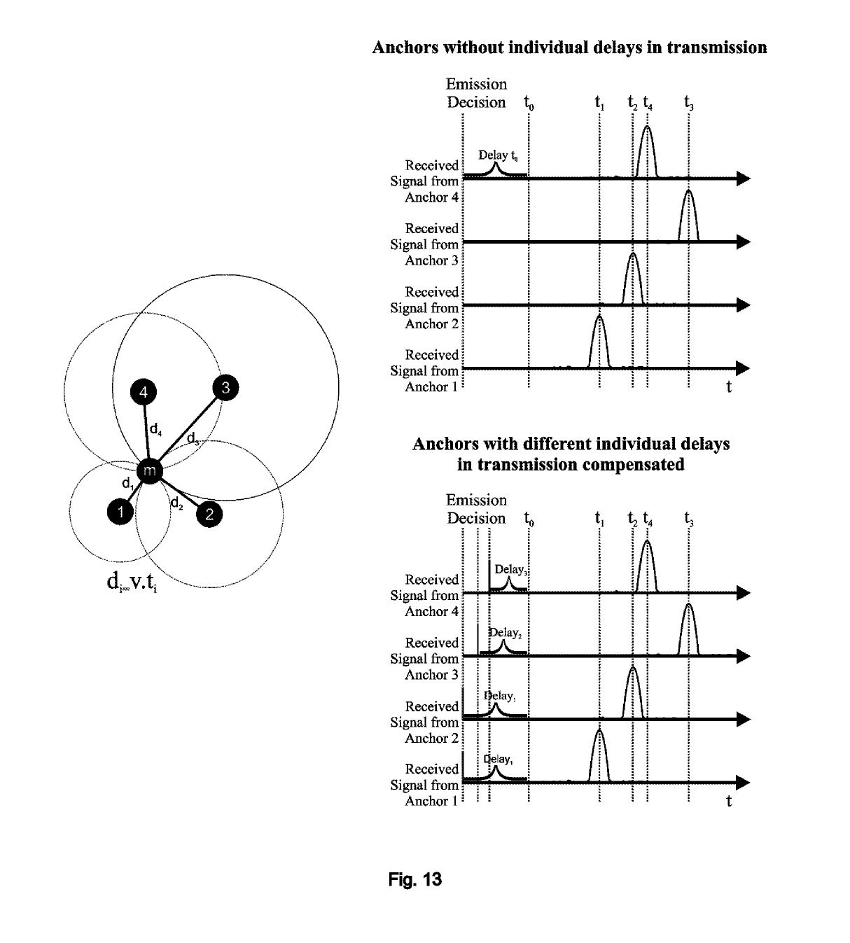

The use of Spread Spectrum allows the transmitted signal to have a low power density due to the fact that the transmitted energy is spread over a wide band, and therefore, the amount of energy per specific frequency is lower as FIG. 9 illustrates in a situation where the localization signal (carrying information and the beacon's id) lies below the environmental noise level. Consequently this low power density of the transmitted signal is that such a signal will not disturb or interfere with receivers in the same area either persons or other mobile devices.

The term “comprising” whenever used in this document is intended to indicate the presence of stated features, integers, steps, components, but not to preclude the presence or addition of one or more other features, integers, steps, components or groups thereof.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

It is to be appreciated that certain embodiments of the disclosure as described herein may be incorporated as code (e.g., a software algorithm or program) residing in firmware and/or on computer useable medium having control logic for enabling execution on a computer system having a computer processor, such as any of the servers described herein. Such a computer system typically includes memory storage configured to provide output from execution of the code which configures a processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The disclosure should not be seen in any way restricted to the embodiments described and a person with ordinary skill in the art will foresee many possibilities to modifications thereof. The above described embodiments are combinable. The following claims further set out particular embodiments of the disclosure.

1. A method for location positioning with steganographic encoded data streams in audible-frequency range audio comprising:
encoding, modulating and audio-hiding a data stream into an audible-frequency range steganographic audio signal;
transmitting said audio signal by a loudspeaker, wherein said data stream includes the geographic location of the loudspeaker;
using a mobile device for:
acquiring an audio signal from the acoustic environment that includes the transmitted audio signal;
separating, demodulating and decoding the data stream from the acquired audio signal; and
estimating a geographic location of the mobile device based on the geographic location of the loudspeaker.

2. The method for location positioning with steganographic encoded data streams in audible-frequency range audio according to claim 1, wherein said data stream includes the geographic location of the loudspeaker and a time stamp of transmission of periodic frames of the data stream and further comprising:
calculating, using the mobile device, a distance between the mobile device and the loudspeaker based on a time of flight between transmission and acquisition of the audio signal, the time of flight being obtained from a difference between a time of acquisition and a time of transmission of the audio signal; and
estimating, using the mobile device, the geographic location of the mobile device based on the calculated distance between the mobile device and the loudspeaker and on the geographic location of the loudspeaker.

3. The method for location positioning with steganographic encoded data streams in audible-frequency range audio according to claim 1, further comprising:
encoding, modulating and audio-hiding two or more data streams each into a corresponding audible-frequency steganographic audio signal;
transmitting each said audio signal by a corresponding loudspeaker, wherein each said data stream includes a geographic location of the corresponding loudspeaker and a time stamp of transmission of periodic frames of the data stream;
using the mobile device for:
acquiring the audio signal from the acoustic environment, wherein the acquired audio signal includes the transmitted audio signals;
separating, demodulating and decoding the data streams from the acquired audio signal;
calculating a distance between the mobile device and each of the loudspeakers based on a time of flight between transmission and acquisition of each of the audio signals, the time of flight being obtained from difference between a time of acquisition and a time of transmission of each of the audio signals; and
estimating the geographic location of the mobile device based on the calculated distance between the mobile device and each of the loudspeakers and on the geographic location of each of the loudspeakers.

4. The method according to claim 3, wherein there are at least three data streams, three corresponding audio signals and three corresponding loudspeakers, and the method further comprising:
trilateration of the distances between the mobile device and each of the loudspeakers, wherein trilateration includes calculating a centroid of an intersection of circles centered on the loudspeakers and having a corresponding radius equal to the distance between the mobile device and each of the loudspeakers.

5. The method according to claim 4, wherein the loudspeakers are synchronized in their transmission such that the same corresponding frame of the data streams is transmitted simultaneously by all the loudspeakers.

6. The method according to claim 4, wherein the loudspeakers are not synchronized in their transmission and the same corresponding frame of the data streams is transmitted by the loudspeakers with a delay specific to each loudspeaker,
wherein the data stream of each loudspeaker includes the corresponding specific delay and the calculation of the time of flight deducts said specific delay for each loudspeaker.

7. The method according to claim 1, wherein the encoded data stream includes error-checking data or error-correction data.

8. The method according to claim 1, wherein the audio-hiding is echo-hiding when the loudspeakers are transmitting one or more further audio signals and wherein the audio-hiding is spread-spectrum when the loudspeakers are not transmitting any further audio signal.

9. The method according to claim 1, wherein an audible-frequency range steganographic audio signal is an audible-frequency audio signal that is below human perceptual threshold.

10. The method according to claim 1, wherein the encoding is Golay encoding.

11. The method according to claim 1, wherein the data stream includes a local air temperature measured at the loudspeaker.

12. The method according to the claim 1, further comprising:
calculating a time of flight by deducting a variation of speed of sound calculated from received temperature data.

13. The method according to claim 1, wherein the data stream includes general interest data to the user of the mobile device, in particular public emergency data.

14. A system for location positioning with steganographic encoded data streams in audible-frequency range audio, comprising:
an encoder-modulator for audio-hiding a data stream into an audible-frequency steganographic audio signal for transmitting to a loudspeaker,
wherein said data stream includes the geographic location of the loudspeaker.

15. The system according to claim 14, wherein said data stream includes periodic frames each with a time stamp.

16. The system according to claim 14, further comprising:
a signal injector for injecting said audio signal into an existing audio signal line; and
further in particular comprising a loudspeaker for transmitting said audio signal.

17. A mobile device for location positioning with steganographic encoded data streams in audible-frequency range audio, comprising a processor and code, wherein the processor of the mobile device is configured by the code to:
acquire an audio signal from an acoustic environment that includes a transmitted audible-frequency steganographic audio signal transmitted by a loudspeaker, wherein said transmitted audio signal has an encoded, modulated and audio-hidden data stream, wherein said data stream includes a geographic location of the loudspeaker;
separate, demodulate, and decode the data stream from the acquired audio signal; and
estimate the geographic location of the mobile device based on the geographic location of the loudspeaker.

18. The mobile device for location positioning with steganographic encoded data streams in audible-frequency range audio according to claim 17, wherein the processor of the mobile device is further configured by the code to:
acquire the audio signal from the acoustic environment that includes the transmitted audible-frequency steganographic audio signal transmitted by the loudspeaker, wherein said transmitted audio signal has the encoded, modulated and audio-hidden data stream, wherein said data stream includes the geographic location of the loudspeaker and a time stamp of transmission of periodic frames of the data stream;
separate, demodulate and decode the data stream from the acquired audio signal;
calculate a distance between the mobile device and the loudspeaker based on a time of flight between transmission and acquisition of the audio signal, the time of flight being obtained from difference between a time of acquisition and a time of transmission of the audio signal; and
estimate the geographic location of the mobile device based on the distance between the mobile device and the loudspeaker and on the geographic location of the loudspeaker.

19. The mobile device for location positioning with steganographic encoded data streams in audible-frequency audio according to claim 17, wherein the processor of the mobile device is further configured by the code to:
acquire the audio signal from the acoustic environment, wherein the acquired audio signal includes two or more transmitted audible-frequency steganographic audio signals each transmitted by a corresponding loudspeaker, wherein each said transmitted audio signal has an encoded, modulated and audio-hidden data stream, wherein said data stream includes a geographic location of the loudspeaker and a time stamp of transmission of periodic frames of the data stream;
separate, demodulate and decode the data stream from the acquired audio signal;
calculate the distance between the mobile device and each of the loudspeakers based on a time of flight between transmission and acquisition of each of the audio signals, the time of flight being obtained from difference between a time of acquisition and a time of transmission of each of the audio signals; and
estimate the geographic location of the mobile device based on the distance between the mobile device and each of the loudspeakers and on the geographic location of each of the loudspeakers.

20. The system according to claim 14, wherein the data stream includes a local air temperature measured at the loudspeaker.
